(19) United States
(12) Patent Application Publication
(10) Pub. No.: US 2018/0276744 A1
(43) Pub. Date: Sep. 27, 2018

(54) Multicomputer Digital Data Processing to Provide Access and Process Control

(71) Applicant: Bank of America Corporation, Charlotte, NC (US)

(72) Inventors: David Robert Hodgson, Camarillo, CA (US); Marat Mark Akopian, Waxhaw, NC (US)

(21) Appl. No.: 15/464,665

(22) Filed: Mar. 21, 2017

(51) Int. Cl. G06Q 40/02; G06Q 20/10

(52) U.S. Cl. CPC G06Q 40/025; G06Q 20/10

(57) ABSTRACT

Systems for controlling processing of an event are provided. A system may receive a request to initiate an event and the request may cause activation of access and process control functions of the systems. The system may receive event details and requirements may be extracted from the event details. The requirements may include data and/or document requirements necessary to process the event to completion. The event details may be compared to the extracted requirements to determine whether one or more requirements are met. If so, the event may be processed. If not, processing of the event may be suspended and the event may be transmitted to a computing device to prevent further processing of the event. Additional information may be received and evaluated to determine whether the requirements are met. If so, the system may transmit an instruction to the computing device to release the event for further processing.

### BACKGROUND

Aspects of the disclosure relate to electrical computers and data processing systems. In particular, one or more aspects of the disclosure relate to implementing and using a data processing system to provide access and process control functions.

Large enterprise organizations may process a plurality of events. In some examples, users may manually process events that can number into the thousands each month. A manual process to review and evaluate events, determine whether event requirements are met, and the like, is time consuming, inefficient, and prone to errors. Further, some events may involve multiple different entities, amounts, and the like, which may further complicate the evaluation and processing of events.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with providing access and process control for the evaluation and processing of events.

In some examples, a system, computing platform, or the like, may receive a request to initiate an event. In some arrangements, the request to initiate the event may cause activation of access and process control functions of the computing platform. The computing platform may receive event details and, in some examples, requirements may be extracted from the event details. The requirements may include data and/or document requirements necessary to process the event to completion.

In at least some examples, the event details may be compared to the extracted requirements to determine whether one or more requirements are met. For instance, the comparison may be used to determine whether all necessary data has been received whether all necessary documents have been received, and the like. If so, the event may be processed.

If one or more requirements are not met, processing of the event may be suspended and the event may be transmitted to a computing device to prevent further processing of the event. In some examples, additional information may be received and evaluated to determine whether, based on the additional information, the requirements are met. If so, the computing platform may transmit a command or instruction (e.g., a signal) to the computing device to release the event for further processing and the event may be transmitted to the computing platform for further processing.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing and using a data processing system to provide access and process control functions in accordance with one or more aspects described herein;

FIGS. 2A-2D depict an illustrative event sequence for implementing and using a data processing system to provide access and process control functions in accordance with one or more aspects described herein;

FIG. 3 depicts an illustrative method for implementing and using a data processing system to provide access and process control functions, according to one or more aspects described herein;

FIG. 4 depicts an illustrative method of evaluating an account type prior to processing an event to completion according to one or more aspects described herein processing events;

FIG. 5 illustrates one example user interface for providing a notification to a user according to one or more aspects described herein;

FIG. 6 illustrates one example operating environment in which various aspects of the disclosure may be implemented in accordance with one or more aspects described herein; and

FIG. 7 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to using a computing platform to control access and processes associated with processing an event, such as a mortgage, mortgage settlement, or the like. In some examples, a warehouse lender may implement the computing platform to provide access and process control for processing events.

Warehouse lenders are often large financial institutions that provide a line of credit to one or more mortgage lenders. Conventional systems may require individuals to review requirements of each event (e.g., mortgage, mortgage settlement, or the like), confirm whether the requirements have been met, and, if so, execute a funds transaction. In larger facilities, this may include processing up to 50,000 events per month. In arrangements in which an event is pooled into a mortgage backed security, such as under a joint securities control account agreement, the complexities of understanding requirements of each event, determining whether requirements have been met, and the like, are compounded. Further, performing the evaluation and processing of each event manually may be inefficient and prone to errors.

Accordingly, arrangements described herein are directed to a computing platform for controlling access to event information and for controlling processing of events. For instance, a request to initiate an event may be received. The request to initiate the event may be received by the access and process control computing platform and may be received from a user computing device. The request to initiate an event may cause access and process control functions of the computing platform to active. The computing platform may then receive event details, such as agreements, data associated with the event, documents required to process the event to completion, and the like. In some examples, one or more requirements may be extracted from the event details. For instance, one or more data requirements and/or document requirements may be extracted from the event details (e.g., from agreements received).

In some examples, the computing platform may compare the extracted requirements to the received event details (e.g., data associated with the event, documents, or the like) to determine whether the one or more requirements are met. If the one or more requirements are met, the event may be processed to completion and the computing platform may execute a funds transfer.

If the one or more requirements are not met, processing of the event may be suspended and the event may be transferred to a computing device to prevent further processing of the event. Preventing further processing of the event may include restricting access to the event (e.g., to only system administrators), requiring additional approval or secondary user authentication to access the event, prevent access to data associated with the event, and the like.

Additional information associated with the event may be received and analyzed to determine whether the requirements are met. If not, processing of the event will remain suspended. Alternatively, if the requirements are met based on the received additional information, the computing platform may transmit a command or instructions (e.g., transmit an electronic signal) to the computing device to which the event was transferred to release the event (and associated information) and transfer the event to the computing platform for further processing.

In some examples, further processing the event may include processing the event to completion. Processing the event to completion may include executing a funds transfer to a predetermined account. In some examples, the type of account to which the transfer may be made may be limited. Accordingly, the computing platform may determine whether the predetermined account is a type of account eligible to receive the funds transfer and, if so, may execute the funds transfer. If not, a notification may be generated and transmitted to a user.

The computing platform may further provide tracking functions to record events processed, users accessing the system, and the like. In some examples, users may access the system (e.g., via a client portal) to determine a status of one or more events, review previously processed events, and the like.

These and various other arrangements will be discussed more fully below.

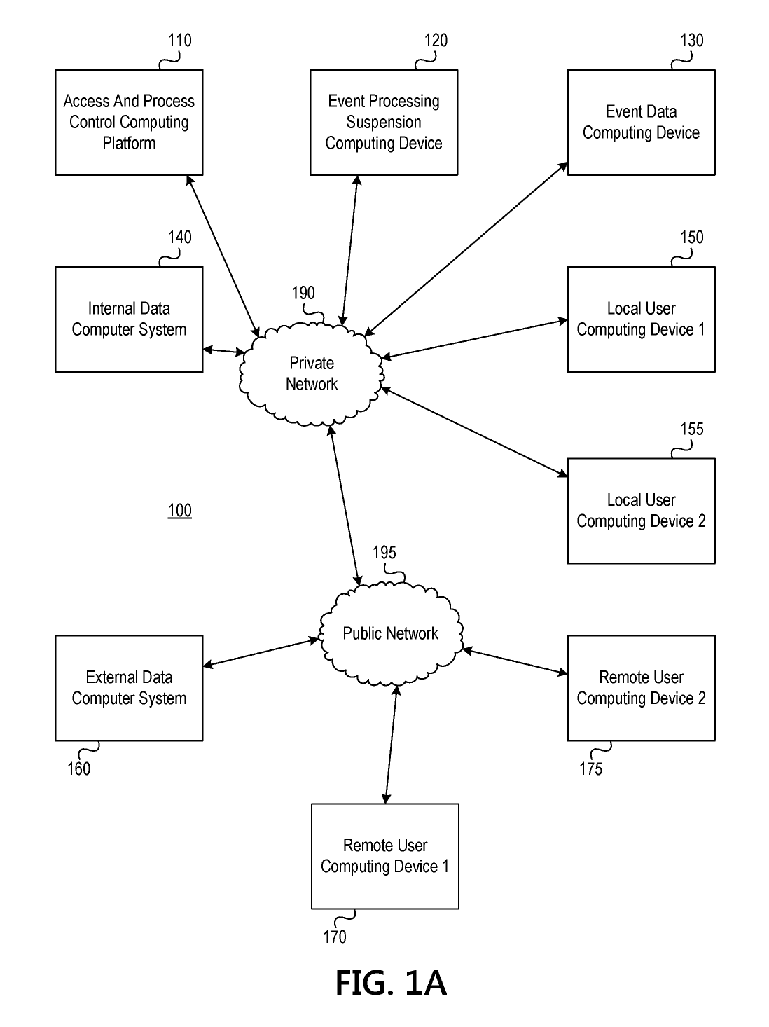

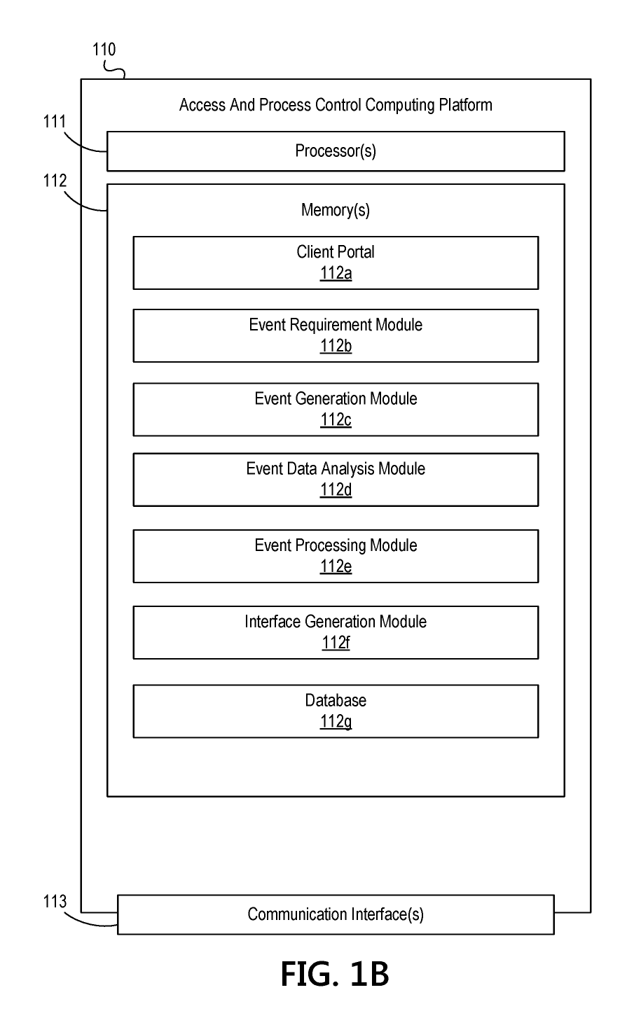

FIGS. 1A and 1B depict an illustrative computing environment for implementing and using an access and process control system in accordance with one or more aspects described herein. Referring to FIG. 1A, computing environment 100 may include one or more computing devices and/or other computing systems. For example, computing environment 100 may include an access and process control computing platform 110, an event processing suspension computing device 120, an event data computing device 130, an internal data computer system 140, an external data computer system 160, a first local user computing device 150, a second local user computing device 155, a first remote user computing device 170, and a second remote user computing device 175.

Access and process control computing platform 110 may be configured to host and/or execute various functions, as discussed in greater detail below. In some instances, access and process control computing platform 110 may receive a request to add an event (e.g., via a client portal), may communicate with one or more computing devices, such as event data computing device 130 to obtain data from a user and/or one or more databases, may evaluate received data to determine whether one or more data requirements are met, may communicate with one or more other computing devices, such as event processing suspension computing device 120, to suspend action on one or more events based on evaluation of received data, and/or may process an event to completion (e.g., transmit funds to authorized account).

In some examples, computing devices, such as event processing suspension computing device 120, event data computing device 130, and the like, may be part of the access and process control computing platform 110. In other examples, one or more of the event processing suspension computing device 120, event data computing device 130, or the like, may be separate devices from the access and process control computing platform 110.

Event data computing device 130 may include hardware and/or software and may be configured to monitor, store, collect and/or transmit data associated with one or more events, such as early purchase events, repurchase events, and the like. In some examples, the data may be received from one or more of local user computing device 150, local user computing device 155, remote user computing device 170, and/or remote user computing device 175. The data may include one or more features, requirements, or the like, associated with the event. For example, features such as a contract date, payoff amount, interest rate, account to which funds may be transferred, and the like, may be received. In some examples, one or more documents may be required to process an event. For instance, documents such as a trade assignment, warehouse release letter, participation certificate, executed agency release letter, and the like, may be required prior to processing the event to completion. These document requirements may be identified to the event data computing device 130 or identification of documents needed may be extracted from other data provided to the event data computing device 130 (e.g., one or more contracts, contract data, event type, or the like). In some examples, data associated with an event may also be received by the event data computing device 130.

In some examples, event data computing device 130 may be configured to receive a bulk upload of data and extract data from the bulk upload to identify one or more events associated with the data. In some examples, the data may be uploaded in a positional file format. The event data computing device 130 may evaluate a format of a file uploaded to determine whether the format is compatible. If so, the data may be uploaded. If not, a notification may be transmitted to a user.

In some examples, event data computing device 130 may receive one or more requirements from internal data computer system 140 and/or external data computer system 160. For example, requirements such as known regulatory requirements for different types of events may be requested from the internal data computer system 140 and/or external data computer system 160. In some examples, the event data computing device 130 may query a database associated with one or more of internal data computer system 140 and/or external data computer system 160 to obtain the requirements. In some arrangements, the query may use as input an event type (e.g. early purchase event, repurchase event, or the like), amount of event, or the like, to identify and obtain the requirements.

Event processing suspension computing device 120 may include hardware and/or software and may be configured to monitor, store, collect and/or transmit data associated with one or more events for which processing has been suspended. For example, in some arrangements, one or more requirements (e.g., data requirements, document requirements, or the like) might not be complete or met by the data received (e.g., received by the event data computing system 130). Accordingly, processing of the event may be suspended and the event (and, for example, associated data, documents, and the like) may be transmitted to event processing suspension computing device 120. The event and associated data may be held at the event processing suspension computing device 120 until all requirements are met. While held at the event processing suspension computing device 120, any further processing of the event may be prevented. For instance, if further data and/or documentation is received related to the event, the event processing suspension computing device 120 may prevent further processing of the event until the newly received data, documents, or the like, have been evaluated, and a request to release the suspended event is received by the event processing suspension computing device 120. Preventing further processing of the event may further include restricting access to the event or data associated with the event (e.g., to system administrator), requiring a second user authentication in order to permit a first user (with appropriate authentication) to access the event, preventing any user access to the event and associated data, and the like.

Local user computing device 150, 155 and remote user computing device 170, 175 may be configured to communicate with and/or connect to one or more computing devices or systems shown in FIG. 1A. For instance, local user computing device 150, 155 may communicate with one or more computing systems or devices via network 190, while remote user computing device 170, 175 may communicate with one or more computing systems or devices via network 195. The local and remote user computing devices may be used to provide access one or more systems, devices, computing platforms, and the like, as well as to display one or more user interfaces, as will be discussed more fully below.

In one or more arrangements, event processing suspension computing device 120, event data computing device 130, internal data computer system 140, external data computer system 160, local user computing device 150, local user computing device 155, remote user computing device 170, and remote user computing device 175 may be any type of computing device capable of receiving a user interface, receiving input via the user interface, and communicating the received input to one or more other computing devices. For example, event processing suspension computing device 120, event data computing device 130, internal data computer system 140, external data computer system 160, local user computing device 150, local user computing device 155, remote user computing device 170, and remote user computing device 175 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of system associated with event processing suspension computing device 120, event data computing device 130, internal data computer system 140, external data computer system 160, local user computing device 150, local user computing device 155, remote user computing device 170, and remote user computing device 175 may, in some instances, be special-purpose computing devices configured to perform specific functions.

Computing environment 100 also may include one or more computing platforms. For example, and as noted above, computing environment 100 may include access and process control computing platform 110. As illustrated in greater detail below, access and process control computing platform 110 may include one or more computing devices configured to perform one or more of the functions described herein. For example, access and process control computing platform 110 may include one or more computers (e.g., laptop computers, desktop computers, servers, server blades, or the like).

As mentioned above, computing environment 100 also may include one or more networks, which may interconnect one or more of access and process control computing platform 110, event processing suspension computing device 120, event data computing device 130, internal data computer system 140, external data computer system 160, local user computing device 150, local user computing device 155, remote user computing device 170, and remote user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, access and process control computing platform 110, event processing suspension computing device 120, event data computing device 130, internal data computer system 140, local user computing device 150, and local user computing device 155 may be associated with an organization (e.g., a financial institution), and private network 190 may be associated with and/or operated by the organization, and may include one or more networks (e.g., LANs, WANs, virtual private networks (VPNs), or the like) that interconnect access and process control computing platform 110, event processing suspension computing device 120, event data computing device 130, internal data computer system 140, local user computing device 150, and local user computing device 155 and one or more other computing devices and/or computer systems that are used by, operated by, and/or otherwise associated with the organization. Public network 195 may connect private network 190 and/or one or more computing devices connected thereto (e.g., access and process control computing platform 110, event processing suspension computing device 120, event data computing device 130, internal data computer system 140, local user computing device 150, and/or local user computing device 155) with one or more networks and/or computing devices that are not associated with the organization. For example, external data computer system 160, remote user computing device 170, and remote user computing device 175 might not be associated with an organization that operates private network 190 (e.g., because external data computer system 160, remote user computing device 170, and remote user computing device 175 may be owned, operated, and/or serviced by one or more entities different from the organization that operates private network 190, such as one or more customers of the organization and/or vendors of the organization, rather than being owned and/or operated by the organization itself or an employee or affiliate of the organization), and public network 195 may include one or more networks (e.g., the internet) that connect external data computer system 160, remote user computing device 170, and remote user computing device 175 to private network 190 and/or one or more computing devices connected thereto (e.g., access and process control computing platform 110, event processing suspension computing device 120, event data computing device 130, internal data computer system 140, local user computing device 150, and/or local user computing device 155).

Referring to FIG. 1B, access and process control computing platform 110 may include one or more processors 111, memory 112, and communication interface 113. A data bus may interconnect processor(s) 111, memory 112, and communication interface 113. Communication interface 113 may be a network interface configured to support communication between access and process control computing platform 110 and one or more networks (e.g., private network 190, public network 195, or the like). Memory 112 may include one or more program modules having instructions that when executed by processor(s) 111 cause access and process control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of access and process control computing platform 110 and/or by different computing devices that may form and/or otherwise make up access and process control computing platform 110. For example, memory 112 may have, store, and/or include a client portal 112a. The client portal 112a may store instructions and/or data that may cause or enable the access and process control computing platform 110 to receive and/or transmit data to one or more other computing devices and related to one or more events, to access, transmit and/or cause to display one or more user interfaces (such as one or more user interfaces generated by user interface generation module 112f), and the like. The client portal 112a may be accessed via one or more of local user computing device 150, 155, remote user computing device 170, 175, or the like. In some examples, the client portal may include authentication information that may be matched to user credentials upon attempting to access the access and process control computing platform 110.

In some examples, the client portal 112a may provide access to historical information, status information, and the like. For instance, the client portal 112a may cause one or more user interfaces to display on a user computing device (e.g., interfaces generated by interface generation module 112f) to display a status of an event being processed, display data associated with previously processed events, and the like. Users may access the client portal 112a to review current status and historical information as desired. In some examples, users may also access the client portal 112a request initiation of an event.

Memory 112 may further have, store and/or include an event requirement module 112b. The event requirement module 112b may store instructions and/or data that may cause or enable the access and process control computing platform 110 to receive one or more event requirements from one or more sources (e.g., event data computing device 130, internal data computer system 140, external data computer system 160, and the like. The requirements may include one or more requirements for data, particular types of data (e.g., based on the event or event type), one or more documents required to process an event (e.g., based on the event or event type), and the like.

Memory 112 may further have, store and/or include event generation module 112c. The event generation module 112c may store instructions and/or data that may cause or enable the access and process control computing platform 110 to generate one or more events for processing. Generating one or more events for processing may include receiving requirements associated with an event, generating an event record (e.g., in database 112g) and associating the received requirements with the event record. Accordingly, the event record for each event may include all requirements (e.g., data and document) to process the event to completion.

Memory 112 may further have, store and/or include event data analysis module 112d. The event data analysis module 112d may store instructions and/or data that may cause or enable the access and process control computing platform 110 to analyze received event data. For example, the received event data (which, in some examples, may include one or more documents) may be compared to requirements for a particular event. If the required data for the event has been received, the event may be further processed. If one or more items relating to the requirements for the event are not available, processing of the event may be suspended, as will be discussed more fully herein.

Memory 112 may further have, store and/or include event processing module 112e. Event processing module 112e may store instructions and/or data that may cause or enable the access and process control computing platform 110 to further process one or more events. For instance, if the requirements for a particular event are met (e.g., as determined by the event data analysis module 112d), the event processing module 112e may receive an instruction or command (e.g., an electronic signal) from, for example, the event data analysis module 112d to process the event to completion. In some examples, processing the event to completion may include executing a wire transfer of funds to a particular account (e.g., a predetermined account).

In some examples, the predetermined account may be provided with, for example, the event data. A type of the predetermined account may be determined or identified (e.g., from data associated with the account). In some examples, the event processing module 112e may be configured to only execute a transfer of funds to predetermined types of accounts. Accordingly, the event processing module 112e may evaluate the account type associated with the predetermined account and may determine whether the account type is eligible to receive funds transfers from the access and process control computing platform 110. If so, the event processing module 112e may transmit a signal or command to execute a transfer of funds. If not, one or more notifications may be generated (e.g., by user interface generation module 112f) and may be transmitted to a user device (e.g., such as local user computing device 150, 155, remote user computing device 170, 175, or the like). The event processing module 112e may cause the interface to be displayed on the device.

If the requirements for a particular event are not met (e.g., as determined by event data analysis module 112d) the event processing module 112e may suspend processing of the event and may transmit the event (and, in some examples, associated data) to event processing suspension computing device 120. The event processing suspension computing device 120 may hold the event and may prevent further processing of the event until the event is released by the access and process control computing platform 110.

For instance, if additional information associated with the event is received by the computing platform 110 (e.g., via the event data computing device 130) the additional information may be processed and evaluated to determine whether all requirements are met. If not, the additional information may be transmitted to the event processing suspension computing device 120 to be held with the event and other associated data. If all requirements are met, the event processing module 112e may transmit a signal, instruction or command to the event processing suspension computing device 120 to release the event. Upon receiving the instruction to release the event, the event processing suspension computing device 120 may transmit the event and associated data to the access and process control computing platform 110 for further processing.

Memory 112 may further have, store and/or include an interface generation module 112f. The interface generation module 112f may store instructions and/or data that may cause or enable the access and process control computing platform 110 to generate one or more user interfaces. For example, the user interface generation module 112f may generate one or more user interfaces enabling a client to interface with access and process control computing platform via the client portal 112a. In another example, the interface generation module 112f may generate one or more notifications to a user, one or more user interfaces for entering data, one or more user interfaces for confirming a status of an event, and the like.

As discussed above, access and process control computing platform 110 may further include a database 112g. The database 112g may store one or more event records, associated data, and the like. In some examples, one or more requirements, documents, and the like, may also be stored in database 112g.

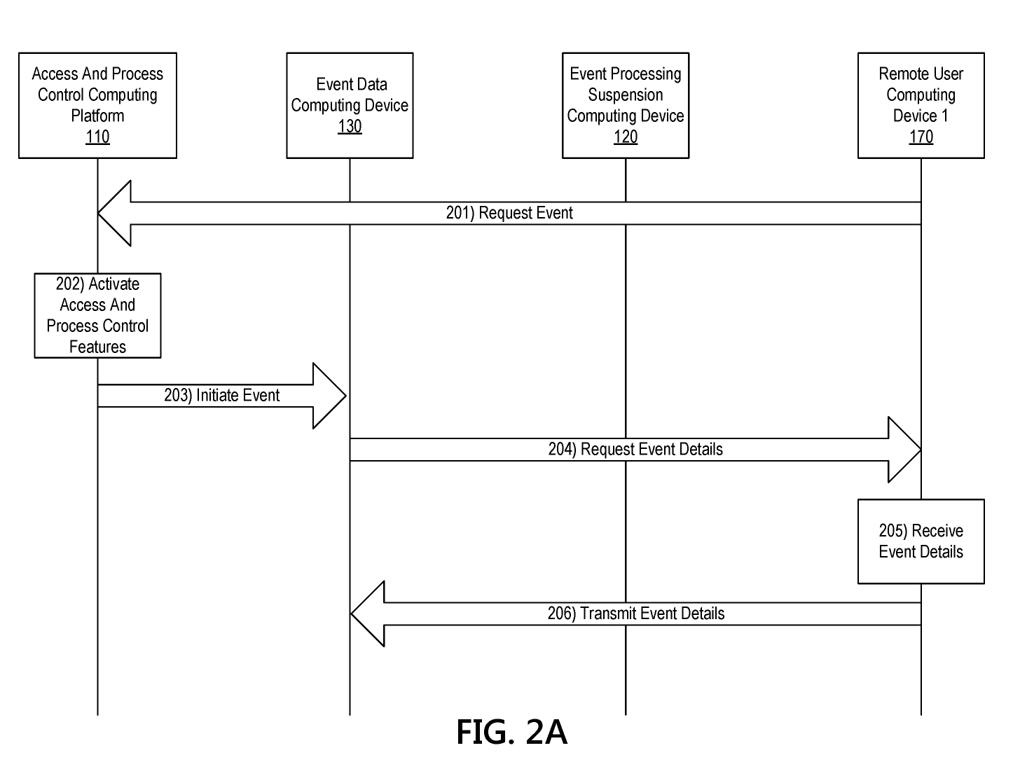

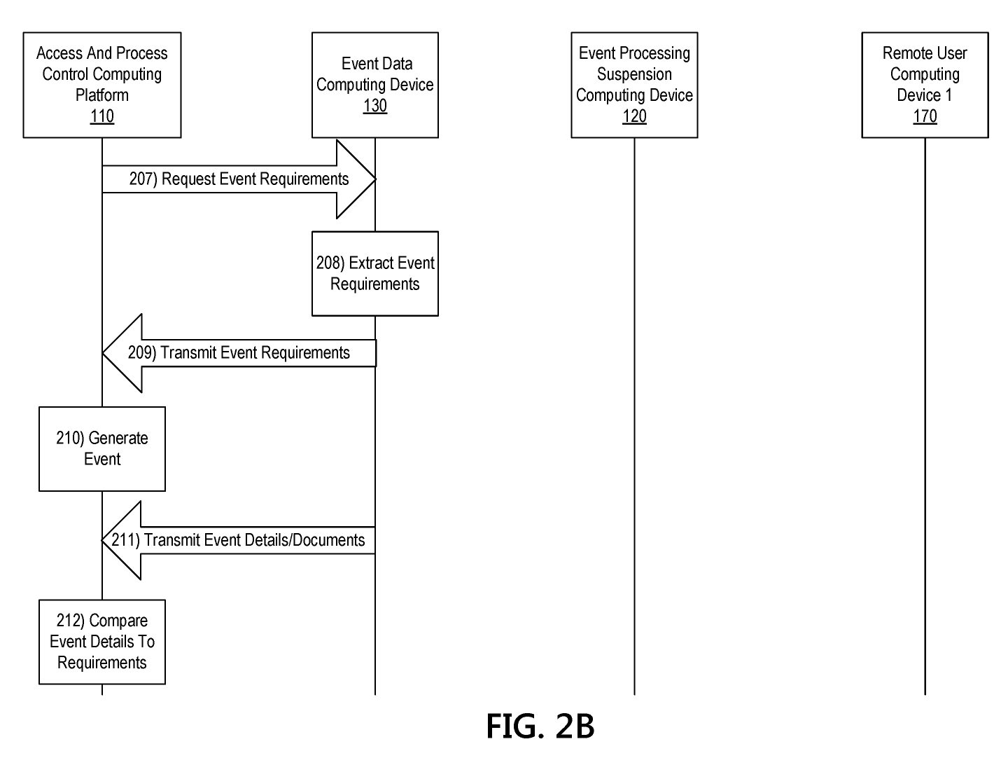

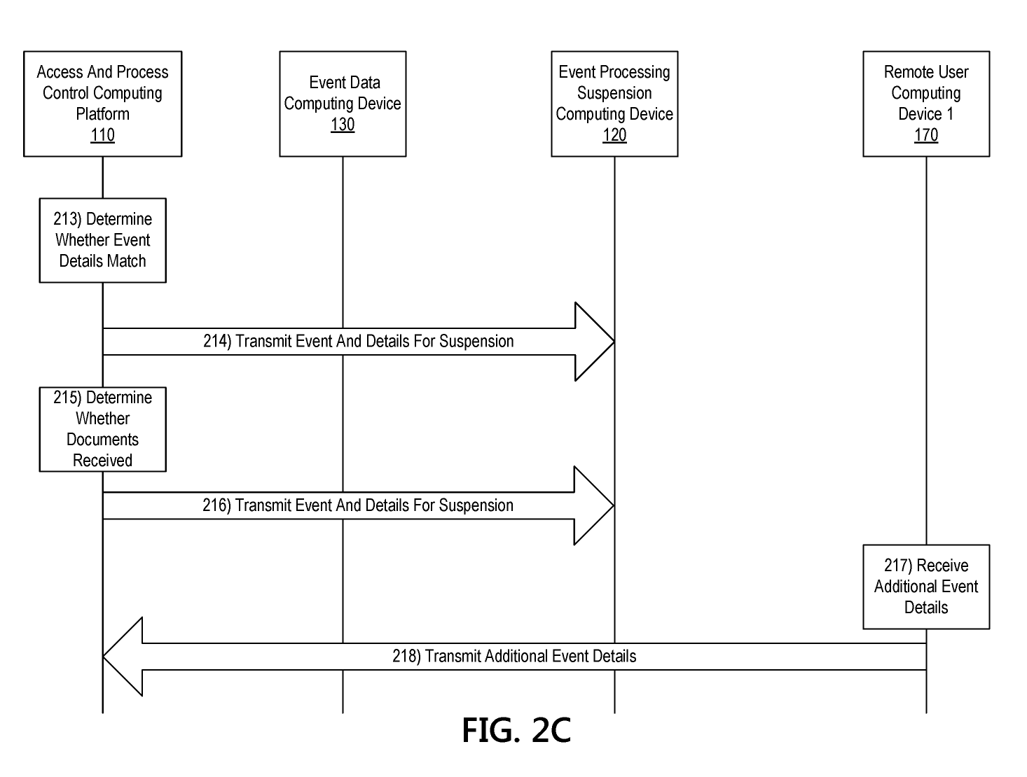

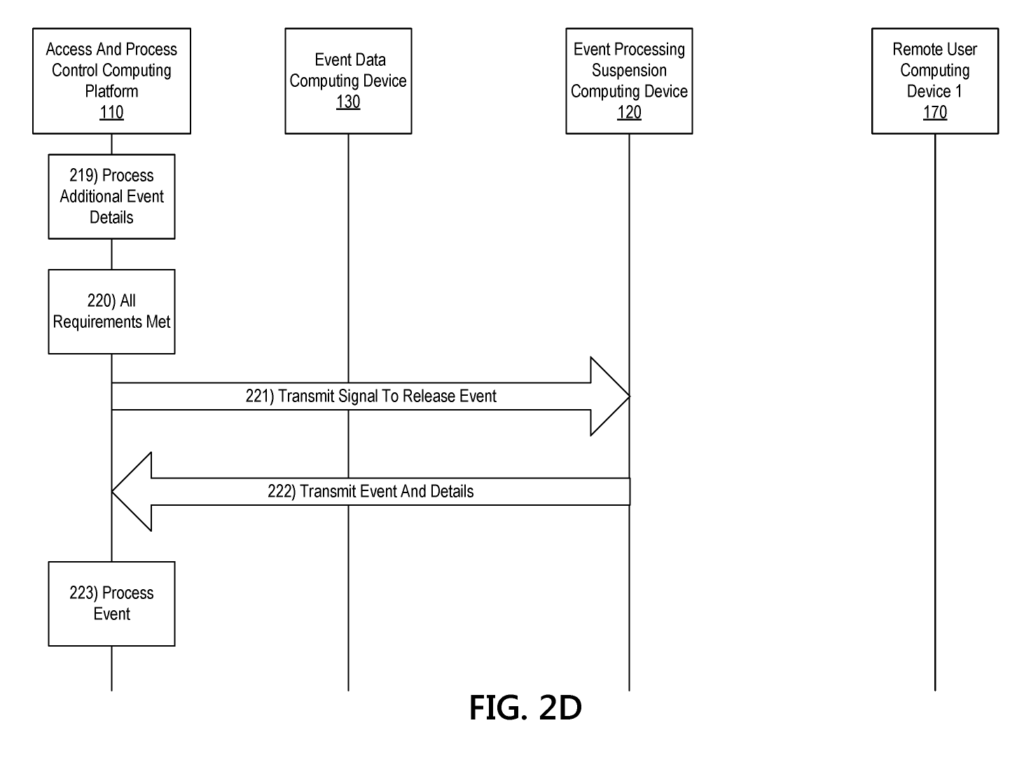

FIGS. 2A-2D depict an illustrative event sequence for implementing and using access and process control computing platform and associated computing systems and devices to perform access and process control functions in accordance with one or more aspects described herein. The events shown in the illustrative event sequence are merely one example sequence and additional events may be added, or events may be omitted, without departing from the invention.

Referring to FIG. 2A, at step 201, a request for an event may be received by the access and process control computing platform 110. In some examples, the request may be received from a remote user computing device 170 and may be received via a client portal of the access and process control computing platform 110. The request for an event may include a request to discharge a loan, execute a transfer of funds to complete processing of an event, or the like.

In step 202, the access and process control computing platform 110 may be activated upon receiving the request for the event. Activating the access and process control computing platform 110 may include powering on one or more devices or systems, initiating one or more sequence, and the like.

In step 203, an event may be initiating. Initiating an event may include transmitting an instruction to initiate an event to event data computing device 130. The event data computing device 130 may then transmit a request for event details to, for instance, the remote user computing device 170 (or other device from which the request for event was received) in step 204.

In step 205, one or more event details may be received by the remote user computing device 170. In some examples, the event details may be received via one or more user interfaces generated by the access and process control computing platform 110 and displayed on the remote user computing device 170 via the client portal. In step 206, the received event details may be transmitted to the event data computing device 130.

With reference to FIG. 2B, in step 207, event requirements may be requested from the event data computing device 130. In some examples, one or more event requirements may be stored in one or more modules of the access and process control computing platform 110, may be received from one or more internal or external computing devices, or the like. In step 208, one or more requirements may be extracted from the received event details and may be transmitted to the access and process control computing platform 110 in step 209.

In step 210, an event may be generated. As discussed above, an event generation module 112c may receive one or more event requirements and may generate an event record. The event record may include an identifier associated with the event, one or more event requirements, and the like. In some examples, the event record may be stored in database 112g.

In step 211, event details and/or documents received (e.g., from remote user computing device 170) may be transmitted to the access and process control computing platform 110. In step 212, the received event details and documents may be compared requirements stored in the event record to determine whether all requirements have been met.

With reference to FIG. 2C, in step 213, the access and process control computing platform 110 may evaluate the received event details as compared to event requirements in the event record to determine whether all data requirements have been met. If not, in step 214, the event and associated data, and the like, may be transmitted to event processing suspension computing device 120, which may prevent further processing of the event.

If the data requirements have been met, in step 215, the access and process control computing platform 110 may evaluate received documents to determine whether all document requirements have been met. If not, the event and associated data, documents, and the like, may be transmitted to the event processing suspension computing device 120, which may prevent further processing of the event, in step 216.

If an event is transmitted to the event processing suspension computing device 120, additional details may be needed in order to release the event and complete processing of the event. In step 217, additional details associated with the event may be received, e.g., at remote user computing device 170. The additional details may be transmitted to the access and process control computing platform 110 in step 218.

With reference to FIG. 2D, in step 219, the additional event details may be processed (e.g., by event data analysis module 112d) to evaluate the additional event details against requirements in the event data record. If all requirements are not met (e.g., after evaluating the additional event details), the event will continue to be held by the event processing suspension computing device 120. In step 220, the access and process control computing platform may determine that all event requirements have been met.

In step 221, the access and process control computing platform 110 may transmit a signal, command or instruction to the event processing suspension computing device 120 to release the suspended event. In step 222, the event and associated details, documents, and the like, may be transmitted to the access and process control computing platform for further processing. In step 223, the event may be processed to completion and, in some examples, the access and process control computing platform 110 may execute a transfer of funds to complete processing the event. As discussed herein, in some examples, restrictions on a type of account to which funds may be transmitted may be used. Accordingly, prior to executing a transfer of funds, the access and process control computing platform 110 may evaluate a type of account scheduled to receive the funds and, if not an authorized type of account, the transfer might not be executed and, instead, a notification may be generated and transmitted to the user (e.g., the access and process control computing platform 110 may generate a user interface and cause the user interface to display on a computing device of the user, such as remote user computing device 170).

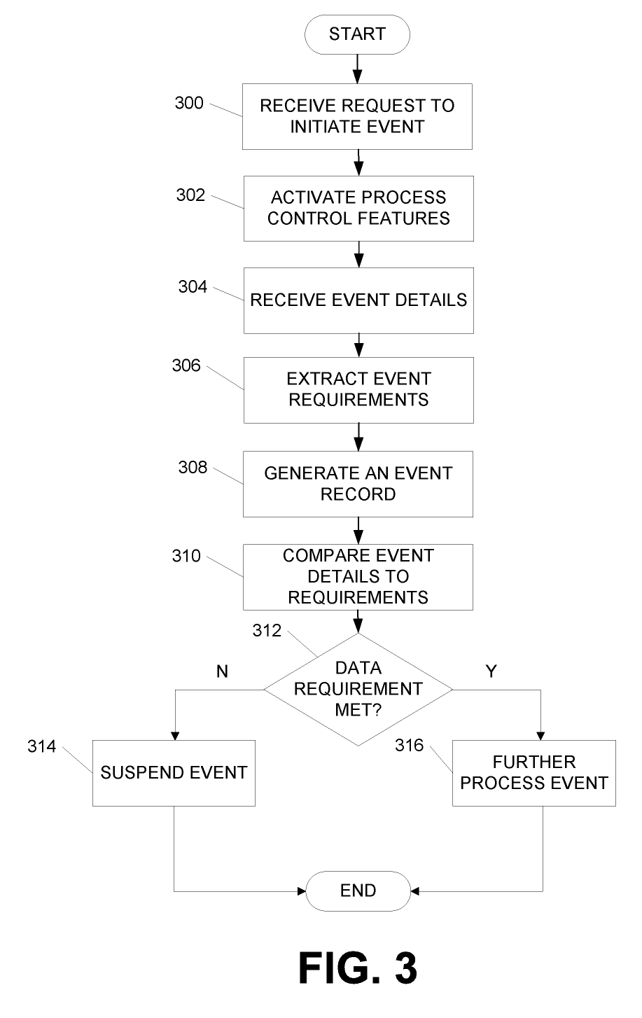

FIG. 3 is a flow chart illustrating one example method of providing process control functions according to one or more aspects described herein. In step 300, a request to initiate an event may be received. For instance, the request to initiate the event may be received by an access and process control computing platform 110 from a user computing device. In step 302, process control features of the access and process control computing platform 110 may be activated in response to receiving the request to initiate the event.

In step 304, event details may be received. In some examples, event details may include one or more contracts or agreements associated with the event, data associated with the event, one or more documents associated with the event, and the like. In some examples, the event details may be received from a user computing device by an event data computing device 130 and may be transmitted from the event data computing device 130 to the access and process control computing platform 110. In other examples, the event data computing device 130 may be part of the access and process control computing platform 110. In still other examples, the event details may be transmitted directly from a user computing device to the access and process control computing platform 110.

In step 306, one or more event requirements may be extracted from the event details. In some examples, the event requirements may be extracted from the one or more contracts or agreements received in the event details. The event requirements may include one or more data requirements, one or more document requirements, and the like.

In step 308, an event record may be generated. The event record may include an event identifier (e.g., an alphanumeric or other identifier unique to the event). The event record may also include extracted event requirements, event details, and the like. In step 310, the event details may be compared to the extracted event requirements. For instance, data associated with the event, and the like, received with the event details may be compared to the extracted event requirements.

In step 312, a determination may be made as to whether at least one data requirement has been met (e.g., based on the comparison of the event details to the event requirements). In some examples, the determination may include determining whether all data requirements have been met.

If, in step 312, the at least one data requirement has been met, the access and process control computing platform 110 may further process the event (e.g., evaluate other requirements, process to completion, execute a funds transfer, or the like). If, in step 314, the at least one data requirement has not been met, processing of the event may be suspended and the event may be transferred to an event processing suspension computing device 120 to prevent further processing of the event. Transferring the event may include transferring the event record, event details, and/or event requirements.

If, in step 312, the at least one data requirement has been met, the event may be further processed in step 316. Further processing the event may include evaluating one or more data requirements, processing the event to completion, executing a funds transfer, and the like, as discussed herein.

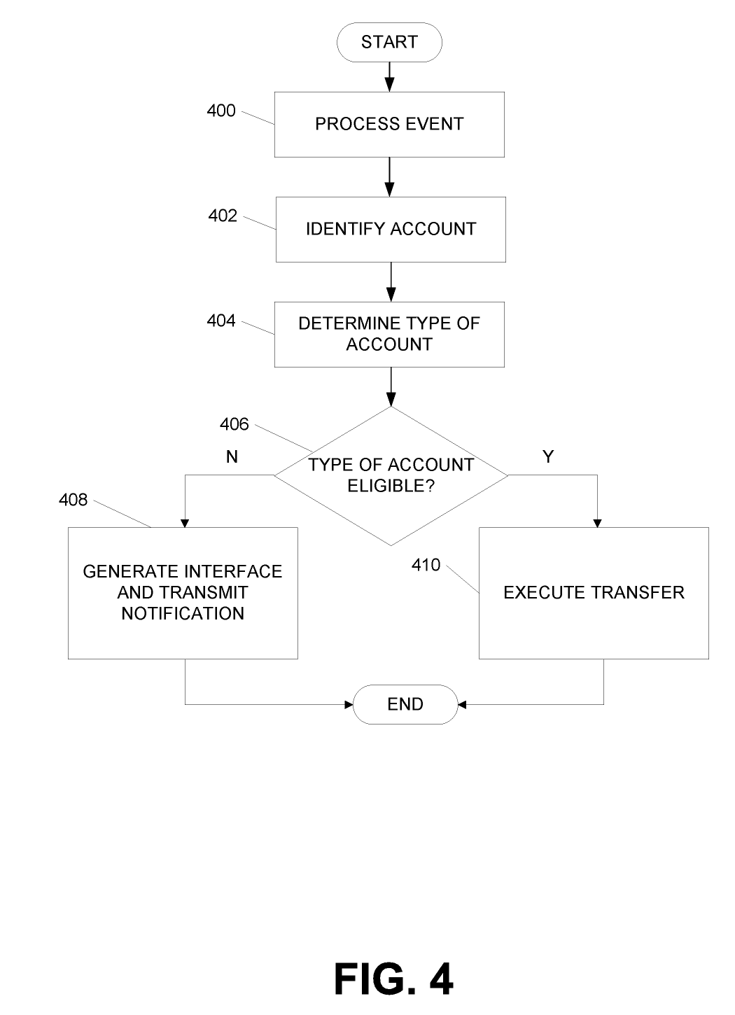

FIG. 4 illustrates one example method of evaluating an account type prior to processing an event to completion according to one or more aspects described herein. In step 400, an event may be processed (e.g., according to description associated with FIGS. 1A, 1B, 2A-2D, 3, and the like). Processing the event may include executing a funds transfer. Accordingly, in step 402, an account to which the funds should be transferred may be identified. The account may be identified from one or more event details received by the access and process control computing platform 110.

In step 404, a type of account may be determined. For example, the system may limit the types of accounts to which funds may be transferred. In some arrangements, accounts of a first type may be able to receive a transfer, while accounts of a second type may be prevented from receiving a transfer.

In step 406, a determination may be made as to whether the determined type of account is eligible to receive funds via the funds transfer. If so, the access and process control computing platform may execute a funds transfer in step 410. Alternatively, if the determined type of account is not eligible to receive funds via the funds transfer, an interface may be generated including a notification in step 408. The interface may be transmitted to one or more computing devices (e.g., user computing devices 150, 155, 170, 175) and the access and process control computing platform 110 may cause the interface to be displayed (e.g., may transmit a command or instruction to display the interface). The interface may include an indication that the account is not eligible and/or that funds will be held and cannot be transferred.

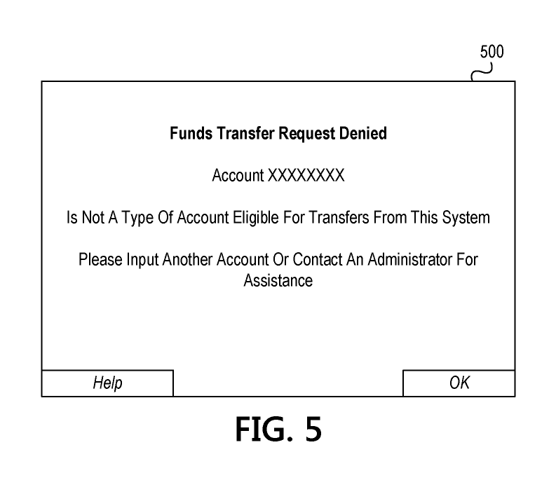

FIG. 5 illustrates one example interface 500. The interface includes an indication that the funds transfer request has been denied because the designated account is not eligible to receive the funds transfer. In some examples, an option for help may be provided via the user interface 500.

As discussed herein, the access and process control computing platform may permit efficient and accurate processing of events, and control of event processing. By extracting requirements from received data, comparing requirements to received data, and evaluating whether requirements are met before executing a funds transfer, the computing platform may quickly and accurately process the thousands of events being evaluated in any given month by a warehouse lender.

The systems and arrangements described herein provide for automatic settlement of events, such as loans, mortgages, and the like, through systems which accurately extract requirements to settle the event, and compare received data to the requirements to determine whether the event can be settled. In some examples, automatic settlement of the event may include automatically executing a funds transfer to settle the event.

The computing platform and other arrangements described herein also provide for efficient tracking of events being processed, users accessing the system, providing data to the system, and the like. Accordingly, logs of events, users, and the like, may be stored by the system and accessed as needed. Further, the computing platform and arrangements described herein may provide for report generation to provide data related to processed events, events currently being processed, suspended events, and the like.

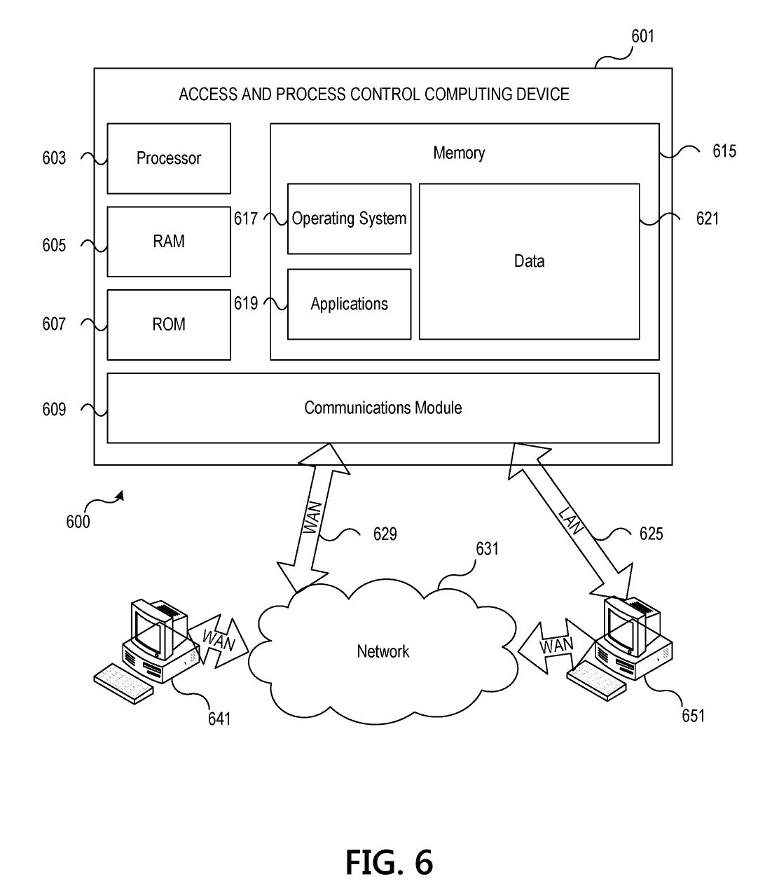

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include access and process control computing device 601 having processor 603 for controlling overall operation of access and process control computing device 601 and its associated components, including Random-Access Memory (RAM) 605, Read-Only Memory (ROM) 607, communications module 609, and memory 615. Access and process control computing device 601 may include a variety of computer readable media. Computer readable media may be any available media that may be accessed by access and process control computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 601.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on access and process control computing device 601. Such a processor may execute computer-executable instructions stored on a computer-readable medium.

Software may be stored within memory 615 and/or storage to provide instructions to processor 603 for enabling access and process control computing device 601 to perform various functions. For example, memory 615 may store software used by access and process control computing device 601, such as operating system 617, application programs 619, and associated database 621. Also, some or all of the computer executable instructions for access and process control computing device 601 may be embodied in hardware or firmware. Although not shown, RAM 605 may include one or more applications representing the application data stored in RAM 605 while access and process control computing device 601 is on and corresponding software applications (e.g., software tasks) are running on access and process control computing device 601.

Communications module 609 may include a microphone, keypad, touch screen, and/or stylus through which a user of access and process control computing device 601 may provide input, and may also include one or more of a speaker for providing audio output and a video display device for providing textual, audiovisual and/or graphical output. Computing system environment 600 may also include optical scanners (not shown). Exemplary usages include scanning and converting paper documents, e.g., correspondence, receipts, and the like, to digital files.

Access and process control computing device 601 may operate in a networked environment supporting connections to one or more remote computing devices, such as computing devices 641 and 651. Computing devices 641 and 651 may be personal computing devices or servers that include any or all of the elements described above relative to access and process control computing device 601.

The network connections depicted in FIG. 6 may include Local Area Network (LAN) 625 and Wide Area Network (WAN) 629, as well as other networks. When used in a LAN networking environment, access and process control computing device 601 may be connected to LAN 625 through a network interface or adapter in communications module 609. When used in a WAN networking environment, access and process control computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

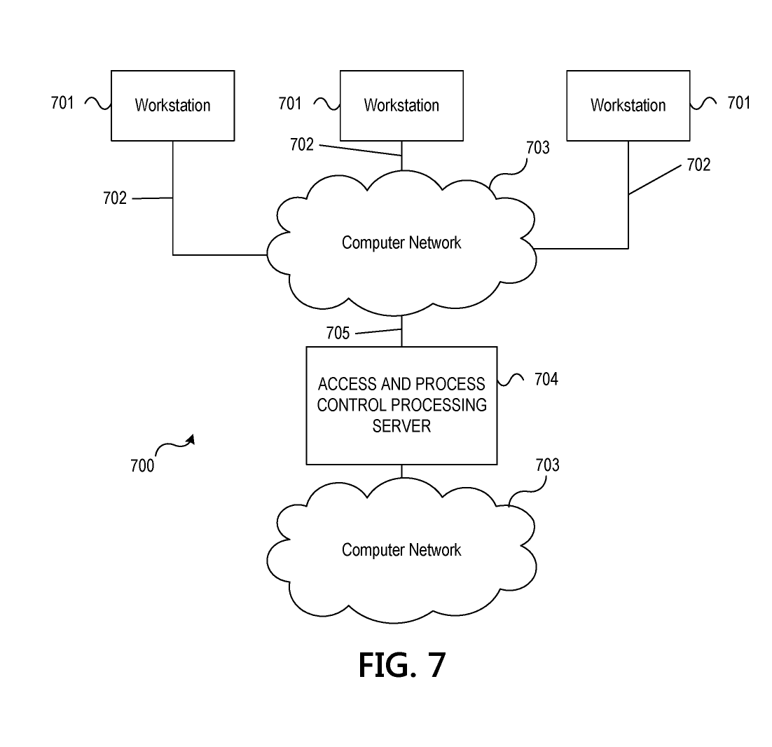

FIG. 7 depicts an illustrative block diagram of workstations and servers that may be used to implement the processes and functions of certain aspects of the present disclosure in accordance with one or more example embodiments. Referring to FIG. 7, illustrative system 700 may be used for implementing example embodiments according to the present disclosure. As illustrated, system 700 may include one or more workstation computers 701. Workstation 701 may be, for example, a desktop computer, a smartphone, a wireless device, a tablet computer, a laptop computer, and the like, configured to perform various processes described herein. Workstations 701 may be local or remote, and may be connected by one of communications links 702 to computer network 703 that is linked via communications link 705 to access and process control processing server 704. In system 700, access and process control processing server 704 may be any suitable server, processor, computer, or data processing device, or combination of the same, configured to perform the functions and/or processes described herein. Server 704 may be used to process received event data, evaluate data, extract requirements, compare data to requirements, evaluate account types, and the like.

Computer network 703 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 702 and 705 may be any communications links suitable for communicating between workstations 701 and access and process control processing server 704, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. An access and process control computing platform, comprising:
at least one processor;
a communication interface communicatively coupled to the at least one processor; and
memory storing computer-readable instructions that, when executed by the at least one processor, cause the access and process control computing platform to:
receive a request to initiate an event;
activate process control features in response to receiving the request to initiate the event;
receive event details, the event details including at least one of: details included in one or more agreements, data associated with the event and documents associated with the event;
extract, from the event details, one or more event requirements, the one or more event requirements including at least one data requirement and at least one document requirement;
generate an event record including at least the extracted event requirements;
compare the event details to the extracted event requirements to determine whether the at least one data requirement is met;
responsive to determining that the at least one data requirement is not met, suspending processing of the event and transmitting the event record to a computing device to prevent further processing of the event; and
responsive to determining that the at least one data requirement is met, further processing the event.

2. The access and process control computing platform of claim 1, further including instructions that, when executed, cause the access and process control computing platform to:
responsive to determining that the at least one data requirement is met, further processing the event including:
comparing the event details to the extracted event requirements to determine whether the at least one document requirement is met;
responsive to determining that the at least one document requirement is not met, suspending processing of the event and transmitting the event record to the computing device to prevent further processing of the event; and
responsive to determining that the at least one document requirement is met, further processing the event.

3. The access and process control computing platform of claim 2, wherein further processing the event includes processing the event to completion.

4. The access and process control computing platform of claim 3, wherein processing the event to completion includes:
identifying an account to which funds will be transferred upon execution of a funds transfer;
determining a type of the account; and
determining whether the determined type of account is eligible to receive the funds transfer.

5. The access and process control computing platform of claim 4, further including instructions that, when executed, cause the access and process control computing platform to:
responsive to determining that the determine type of account is eligible to receive the funds transfer, executing the funds transfer; and
responsive to determining that the determined type of account is not eligible to receive the funds transfer, generating and transmitting a notification to a computing device.

6. The access and process control computing platform of claim 1, further including instructions that, when executed, cause the access and process control computing platform to:
receive additional information related to the event;
analyze the received information to determine whether the at least one data requirement is met;
responsive to determining that the at least one data requirement is not met, continue suspending processing of the event; and
responsive to determining that the at least one data requirement is met, transmitting a signal to the computing device to release the event for further processing.

7. The access and process control computing platform of claim 6, wherein transmitting a signal to the computing device to release the event for further processing further includes:
receiving, from the computing device, the event; and
further processing the event.

8. A method, comprising:
at a computing platform comprising at least one processor, memory, and a communication interface:
receiving, by the at least one processor and via the communication interface, a request to initiate an event;
activating, by the at least one processor, process control features of the computing platform in response to receiving the request to initiate the event;
receiving, by the at least one processor, event details, the event details including at least one of: details included in one or more agreements, data associated with the event and documents associated with the event;
extracting, by the at least one processor and from the event details, one or more event requirements, the one or more event requirements including at least one data requirement and at least one document requirement;
generating, by the at least one processor, an event record including at least the extracted event requirements;
comparing, by the at least one processor, the event details to the extracted event requirements to determine whether the at least one data requirement is met;
responsive to determining that the at least one data requirement is not met, suspending, by the at least one processor, processing of the event and transmitting, by the at least one processor and via the communication interface, the event record to a computing device to prevent further processing of the event; and
responsive to determining that the at least one data requirement is met, further processing, by the at least one processor, the event.

9. The method of claim 8, further including:
responsive to determining that the at least one data requirement is met, further processing the event including:
comparing the event details to the extracted event requirements to determine whether the at least one document requirement is met;
responsive to determining that the at least one document requirement is not met, suspending processing of the event and transmitting the event record to the computing device to prevent further processing of the event; and
responsive to determining that the at least one document requirement is met, further processing the event.

10. The method of claim 9, wherein further processing the event includes processing the event to completion.

11. The method of claim 10, wherein processing the event to completion includes:
identifying an account to which funds will be transferred upon execution of a funds transfer;
determining a type of the account; and
determining whether the determined type of account is eligible to receive the funds transfer.

12. The method of claim 11, further including:
responsive to determining that the determine type of account is eligible to receive the funds transfer, executing the funds transfer; and
responsive to determining that the determined type of account is not eligible to receive the funds transfer, generating and transmitting a notification to a computing device.

13. The method of claim 8, further including:
receiving, by the at least one processor, additional information related to the event;
analyzing, by the at least one processor, the received information to determine whether the at least one data requirement is met;
responsive to determining that the at least one data requirement is not met, continue suspending processing of the event; and
responsive to determining that the at least one data requirement is met, transmitting, by the at least one processor, a signal to the computing device to release the event for further processing.

14. The method of claim 13, wherein transmitting a signal to the computing device to release the event for further processing further includes:
receiving, from the computing device, the event; and
further processing the event.

15. One or more non-transitory computer-readable media storing instructions that, when executed by a computing platform comprising at least one processor, memory, and a communication interface, cause the computing platform to:
receive, via the communication interface, a request to initiate an event;
activate process control features of the computing platform in response to receiving the request to initiate the event;
receive event details, the event details including at least one of: details included in one or more agreements, data associated with the event and documents associated with the event;
extract, from the event details, one or more event requirements, the one or more event requirements including at least one data requirement and at least one document requirement;
generate an event record including at least the extracted event requirements;
compare the event details to the extracted event requirements to determine whether the at least one data requirement is met;
responsive to determining that the at least one data requirement is not met, suspending processing of the event and transmitting the event record to a computing device to prevent further processing of the event; and
responsive to determining that the at least one data requirement is met, further processing the event.

16. The one or more non-transitory computer-readable media of claim 15, further including instructions that, when executed, cause the computing platform to:
responsive to determining that the at least one data requirement is met, further processing the event including:
comparing the event details to the extracted event requirements to determine whether the at least one document requirement is met;
responsive to determining that the at least one document requirement is not met, suspending processing of the event and transmitting the event record to the computing device to prevent further processing of the event; and
responsive to determining that the at least one document requirement is met, further processing the event.

17. The one or more non-transitory computer-readable media of claim 16, wherein further processing the event includes processing the event to completion.

18. The one or more non-transitory computer-readable media of claim 17, wherein processing the event to completion includes:
identifying an account to which funds will be transferred upon execution of a funds transfer;
determining a type of the account; and
determining whether the determined type of account is eligible to receive the funds transfer.

19. The one or more non-transitory computer-readable media of claim 18, further including instructions that, when executed, cause the computing platform to:
responsive to determining that the determine type of account is eligible to receive the funds transfer, executing the funds transfer; and
responsive to determining that the determined type of account is not eligible to receive the funds transfer, generating and transmitting a notification to a computing device.

20. The one or more non-transitory computer-readable media of claim 15, further including instructions that, when executed, cause the computing platform to:
receive additional information related to the event;
analyze the received information to determine whether the at least one data requirement is met;
responsive to determining that the at least one data requirement is not met, continue suspending processing of the event;
responsive to determining that the at least one data requirement is met, transmitting a signal to the computing device to release the event for further processing.

21. The one or more non-transitory computer-readable media of claim 20, wherein transmitting a signal to the computing device to release the event for further processing further includes:
receiving, from the computing device, the event; and
further processing the event.
